(19) United States
(12) Patent Application Publication
(10) Pub. No.: US 2015/0028502 A1
(43) Pub. Date: Jan. 29, 2015

(54) POTABLE WATER DISPENDER

(71) Applicant: K EUROPE S.R.L., LOGRATO (IT)

(72) Inventor: Antonio Fanelli, Calcinato (IT)

(73) Assignee: K EUROPE S.R.L., LOGRATO (IT)

(21) Appl. No.: 14/379,743

(22) PCT Filed: Feb. 18, 2013
(86) PCT No.: PCT/EP2013/053165

§ 371 Date: Aug. 19, 2014

(30) Foreign Application Priority Data
Feb. 21, 2012 (IT) VR2012A000026

(51) Int. Cl. B67D 1/00; B01F 15/04; B01F 3/04

(52) U.S. Cl. CPC B67D 1/0071; B01F 3/04794; B01F 15/0429; B01F 2003/049; B01F 2003/04943; B01F 2003/04822
USPC 261/140.1; 261/59

(57) ABSTRACT

A potable water dispenser comprising a supporting structure for means of producing carbonated water. The means of producing carbonated water comprise at least one dispensing assembly that can be connected hermetically to the mouth of a container and is provided with a water dispensing port that is controlled by a first valve and is adapted to pour into the container a measured quantity of water, and a port for injecting pressurized gas into the container, which can be activated to carbonate the water poured into the container from the dispensing port. In the dispensing assembly there is, moreover, a venting port, which is controlled by a second valve, so as to allow the outflow of air from the container when water is poured into the container by the dispensing port.

The present invention relates to a potable water dispenser.

At present, potable water dispensers are known which are commonly installed in workplaces and are provided with at least one dispensing spout for still and/or fizzy water, optionally refrigerated, which is drawn by users by way of a beaker.

In devices of this type available nowadays on the market, the fizzy water is produced automatically by simultaneously conveying into a chamber for mixing, communicating with a corresponding dispensing spout, the water to be dispensed, which is drawn from a supply source, normally constituted by the water mains, and a flow of low pressure gas, typically constituted by carbon dioxide, which comes from an adapted bottle accommodated in the box-like structure of the device.

The fizzy water thus produced is not, however, of optimal quality, since it is not very carbonated and it tends to lose the gas in a relatively short time.

The aim of the present invention is to solve the drawbacks of the known art, by providing a potable water dispenser that enables an optimal production of fizzy water more or less automatically.

Within this aim, an object of the invention is to provide a potable water dispenser that is capable of producing fizzy water at the temperature appreciated by the user.

Another object of the present invention is to provide a potable water dispenser that enables the user to draw still or fizzy water according to requirements.

Another object of the invention is to provide a potable water dispenser that can easily be obtained using elements and materials that are easily sourced on the market, and which, moreover, can be competitive from a purely economic viewpoint as well.

This aim and these and other objects which will become more apparent hereinafter are all achieved by the potable water dispenser, according to the invention, as defined in claim 1.

Further characteristics and advantages of the invention will become more apparent from the description of a preferred, but not exclusive, embodiment of the potable water dispenser according to the invention, which is illustrated by way of non-limiting example in the accompanying drawings wherein:

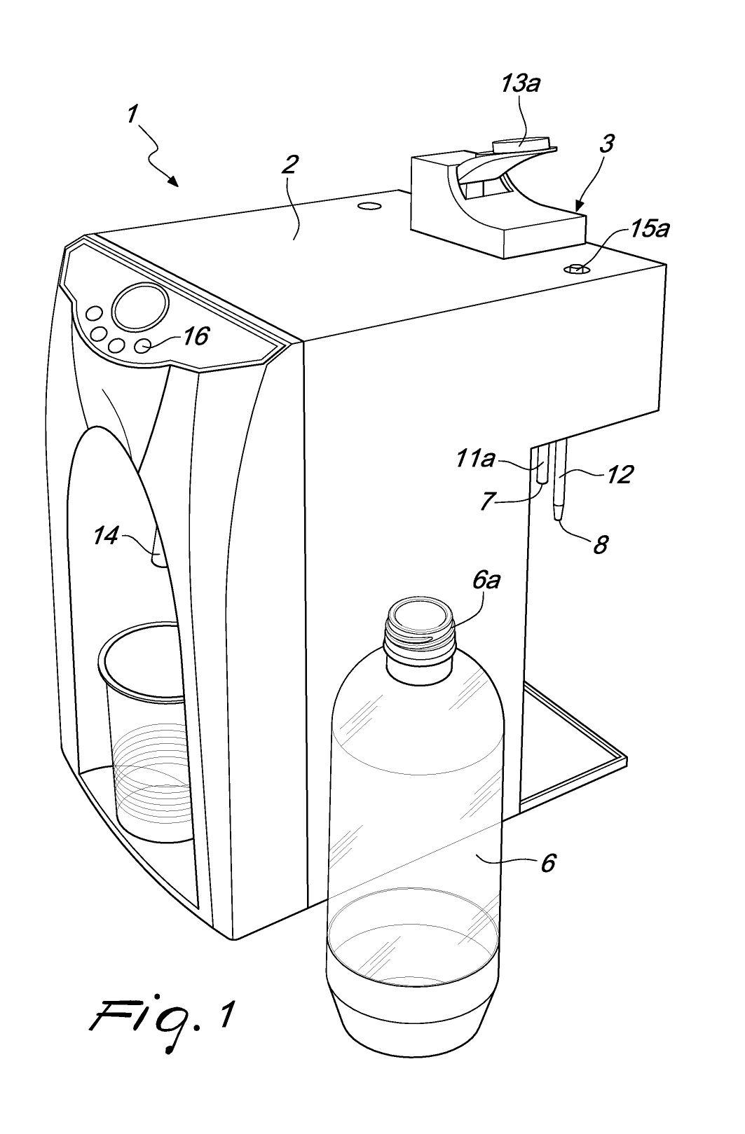

FIG. 1 is a perspective view of the device according to the invention;

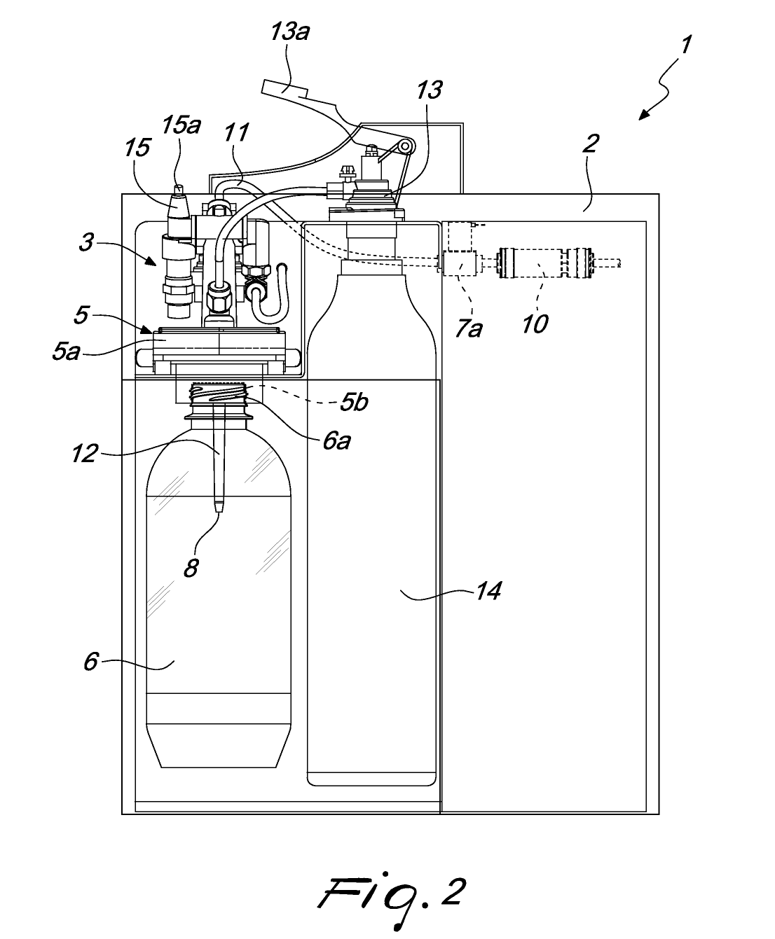

FIG. 2 is a sectional and partially transparent view of the device according to the invention;

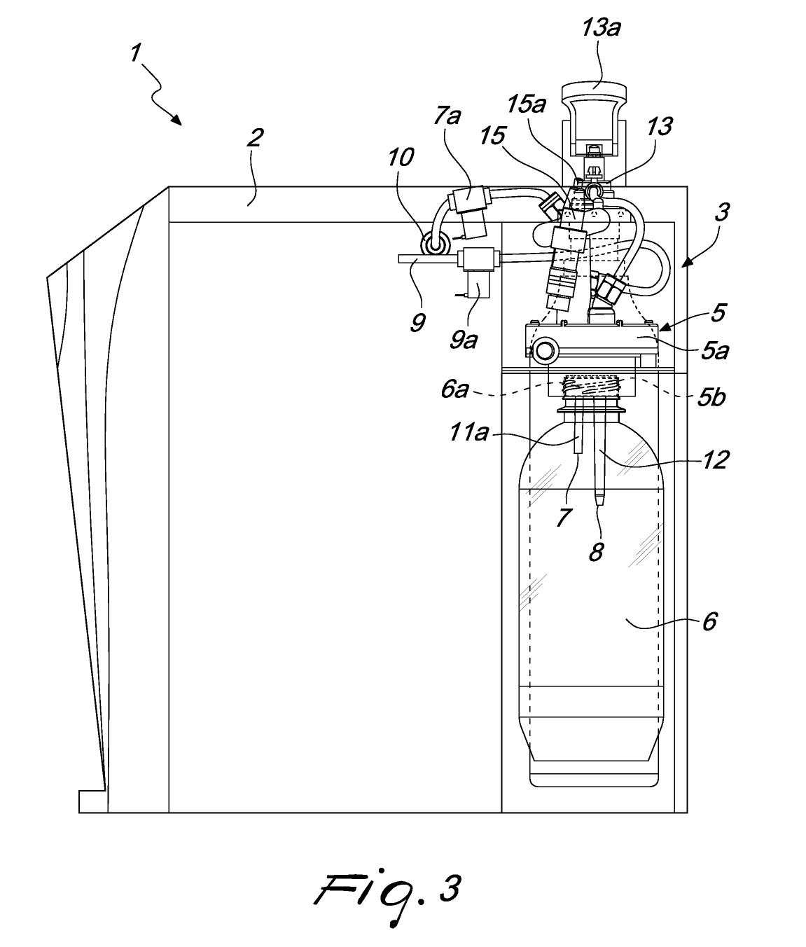

FIG. 3 is another sectional and partially transparent view of the device according to the invention;

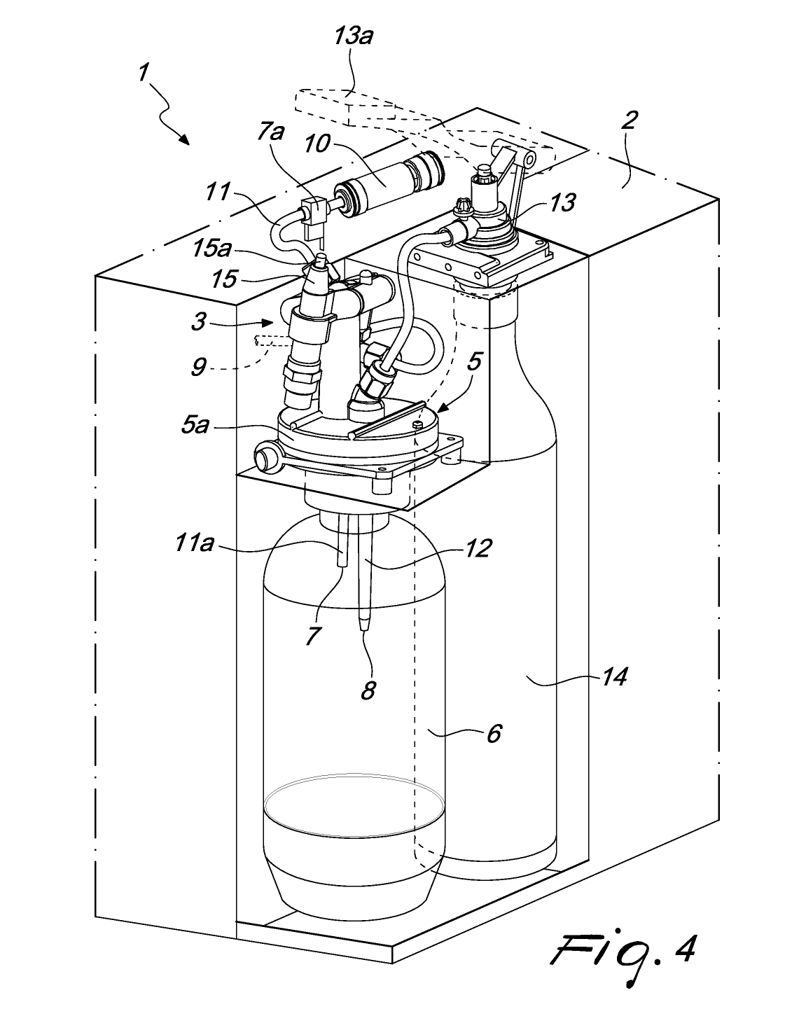

FIG. 4 is a perspective view of a detail of the device according to the invention, with a dispensing assembly highlighted;

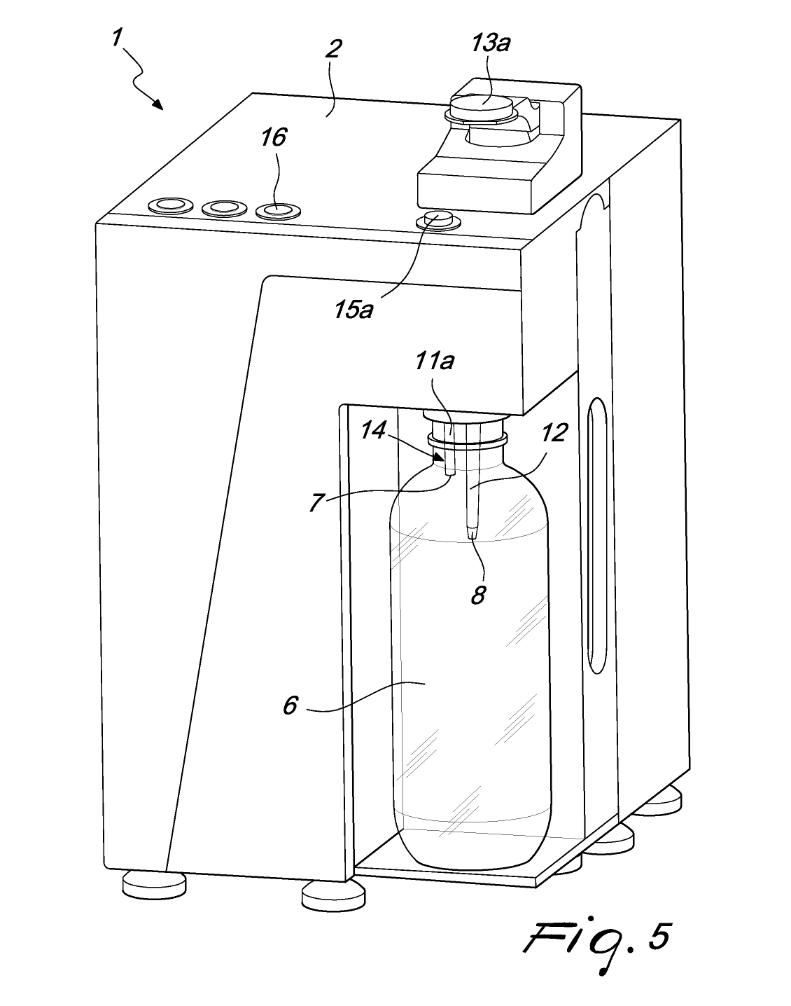

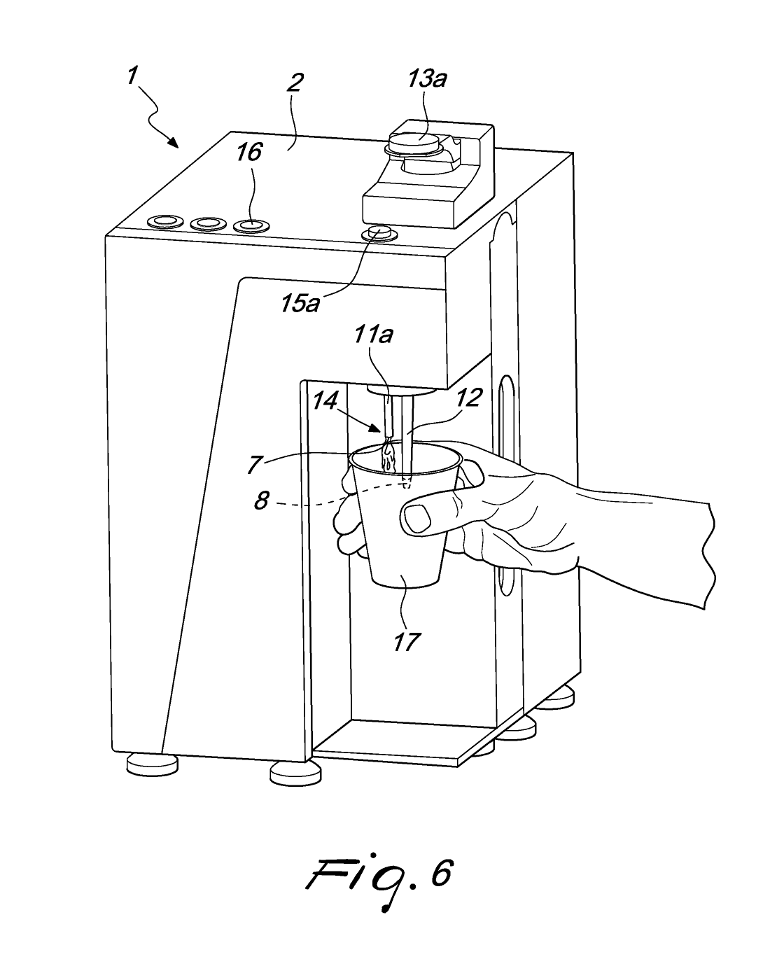

FIGS. 5 and 6 are perspective views of a possible variation of embodiment of the device according to the invention.

With reference to the figures, the potable water dispenser, according to the invention, generally designated with the reference numeral 1, comprises a supporting structure 2, on which means 3 of producing carbonated water are mounted.

According to the invention, such means 3 of producing carbonated water comprise at least one dispensing assembly 5 which is connected, or in any case can be connected, hermetically to the mouth of a container 6 that is, for example, bottle-shaped or the like.

In particular, the dispensing assembly 5 is provided with a dispensing port 7, which is controlled by a first valve 7a and which makes it possible to pour a measured quantity of water into the container 6.

The dispensing assembly 5 is provided, moreover, with an injection port 8 that makes it possible to inject pressurized gas, preferably carbon dioxide, into the container 6 so as to be able to carbonate the water that has been poured into the container 6 through the dispensing port.

Also, there is moreover a venting port 9 in the dispensing assembly 5 which is controlled by a second valve 9a, so as to allow the outflow of air from the container when the measured quantity of water is poured into the container 6 by the dispensing port 7.

Advantageously, both the first valve 7a and the second valve 9a are, respectively, constituted by solenoid valves.

Conveniently, the first valve 7a and the second valve 9a are actuated by control means, which, when the first valve 7a is opened, also command the opening of the second valve 9a, so as to ensure the outward flow of the air present in the container 6 while water is being poured into the container by way of the dispensing port of the dispensing assembly 5.

As illustrated, the dispensing assembly 5 is formed by a single base block 5a, which supports the dispensing port 7 and the injection port 8 as well as the venting port 9.

Delving into further detail, the dispensing port 7 is connected, by way of the first valve 7a, to a potable water source, which, for example, can be constituted by the water mains, to which it can, conveniently, be connected via a connector 10, and/or by a water tank (not shown) which is fitted on the supporting structure 2 and which can be filled as needed by the user with potable water or be substituted, once emptied, with another full tank of water.

As illustrated, the dispensing port 7 is, conveniently, defined at the outlet end of a conveyance duct 11 of the water, which is in communication, at its other end, with the aforementioned potable water source.

In particular, the first valve 7a is interposed along such conveyance duct 11, which, as can be seen from the figures, conveniently passes through a passage defined in the base block 5a of the dispensing assembly 5, so as to be inserted, at least with an end portion 11a thereof, proximate to the dispensing port 7, inside the container 6.

Advantageously, the injection port 8 of the gas is, in turn, defined at the outlet of a tube 12 that is supported by the base block 5a of the dispensing assembly 5 and is intended to be inserted, at least partially, into the container 6.

The injection port 8 is, moreover, connected, through the tube 12 and with the interposition of a drawing valve 13, to a bottle 14 for dispensing the pressurized gas.

For example, such drawing valve 13 can be actuated by the user by means of a command lever 13a, which is accessible outside the supporting structure 2.

Advantageously, means are also provided for the refrigeration of the water which make it possible to cool the water drawn from the potable water source to the temperature preferred by the user to be transferred to the dispensing port 7 through the conduit 11 and the first valve 7a.

Conveniently, such means for refrigeration can be of any conventional type and, in particular, they can, for example, be constituted by a compressor refrigeration assembly with an evaporator in a heat exchange arrangement with the water destined to be dispensed by the dispensing port 7 or by any other adapted device.

Preferably, the container 6 is connected, with its mouth, to the dispensing assembly 5 removably, so as to enable the user, once the carbonated water has been produced in the container 6, to remove the container 6 from the supporting structure 2, by detaching it from the dispensing assembly 5, so as to be able to pour, for example, its contents into a beaker.

To this end, at the mouth of the container 6, for example, a region shaped like an outer screw 6a can be provided, which is capable of being screwed into a corresponding region shaped like an inner screw 5b which is defined on the base block 5a of the dispensing assembly 5.

Also in this case, a venting valve 15 is advantageously also provided in order to enable the outflow from the container 6 of the excess gas injected by the injection port 8, before the container 6 is separated from the dispensing assembly 5.

Conveniently, the venting valve 15 is also supported by the base block 5a of the dispensing assembly 5 and is provided, advantageously, with an activation peg 15a, which is accessible from the outside of the supporting structure 2 and can be actuated in compression by the user to drive the opening of the venting valve 15.

According to a possible embodiment, means can also be provided for drawing the carbonated water produced inside the container 6.

Such means for withdrawal can, for example, be constituted by a pump, not shown, which is capable of drawing from the container 6 with its intake port, and which is connected, with its delivery port, to a nozzle for dispensing the carbonated water, which is fitted on the supporting structure 2, so as to enable the user to draw, through the aforementioned dispensing nozzle, the carbonated water produced inside the container 6.

For completeness, on the supporting structure 2 there is, advantageously, also at least one dispensing spout 14 for still water, by way of which the user can draw still water which he or she can pour, for example, into a beaker.

Such dispensing spout 14 can be positioned in a region of the supporting structure 2 which is different from the region where the dispensing assembly 5 is provided, as in the embodiment shown in the figures, in particular in FIG. 1, or it can be arranged at the dispensing assembly 5, as in the example in FIGS. 5 and 6.

In the latter case, the dispensing spout 14 can be constituted, advantageously, by the dispensing port 7 of the dispensing assembly 5, by way of which the user can thus not only fill the container 6 for the preparation of carbonated water, but can also draw still water, which can be poured directly into a beaker 17, once the container 6 has been separated from the dispensing assembly 5, as shown in FIG. 6.

In general, the dispensing spout 14 is connected to the potable water source directly or with the interposition of a straight-flow pump or other device.

The operation of the device according to the invention is as follows.

With the container 6 hermetically connected to the dispensing assembly 5, the user actuates the opening of the first valve 7a by actuating, for example, a corresponding actuation button 16 placed outside the supporting structure 2, so as to start the pouring of a measured quantity of water into the container 6 by way of the dispensing port 7 of the dispensing assembly 5.

Simultaneously with the opening of the first valve 7a, the control means that control the first and second valves 7a and 9a also actuate the opening of the second valve 9a, so that, while the container 6 is filled with the measured quantity of water dispensed by the dispensing port 7, the air contained in the container 6 can exit through the venting port 9 formed in the dispensing assembly 5.

The measured quantity of water poured into the container 6 by the dispensing port 7 can for example be varied by the user, according to requirements, by way of adapted means for calibration which, in a way that is known per se, make it possible to adjust the opening time of the first valve 7a.

Once the pouring of water into the container 6 has been completed, the first and second valves 7a and 9a are closed and the user then proceeds to actuate the command lever 13a of the drawing valve 13, so as to enable the introduction into the container 6 of the pressurized gas contained in the bottle for dispensing 14 through the injection port 8 of the dispensing assembly 5.

The user can actuate the command lever 13a of the drawing valve 13 one or more times, depending on the degree of effervescence that he or she wishes to provide to the water poured into the container 6.

Once the desired degree of effervescence has been reached for the water poured into the container 6, the user opens the venting valve 15, by way of an action of pressure exerted on its activation peg 15a, so as to allow the excess gas that has not dissolved in the water to exit, and then detaches the container 6 from the dispensing assembly 5, by unscrewing its region shaped like an outer screw 6a from the region shaped like an inner screw 5b of the dispensing assembly 5, so as to be able to use the carbonated water produced inside the container 6.

If applicable, the user can optionally draw the carbonated water from the container 6 by way of the adapted dispensing nozzle as well.

In practice it has been found that the invention is capable of fully achieving the set aim and objects and, in particular, attention is drawn to the fact that the device according to the invention is capable of producing, in a practically semi-automatic manner, carbonated water of higher quality than the dispensing devices currently available on the market.

All the characteristics of the invention, indicated above as advantageous, convenient or similar, may also be missing or be substituted by equivalent characteristics.

The individual characteristics set out with reference to general teachings or to specific embodiments may all be present in other embodiments or may substitute characteristics in such embodiments.

The invention, thus conceived, is susceptible of numerous modifications and variations, all of which are within the scope of the appended claims.

Thus, for example, there could also be an electronic control unit that is adapted to oversee the operation not only of the first and second valves 7a and 9a, but also of the drawing valve 13 and of the venting valve 15, in order to actuate their automatic opening/closing, in the sequential order described above, in response to an activation command imparted by the user by way of an adapted button to start the device, arranged on the supporting structure 2.

In practice the materials employed, as well as the dimensions and shapes, may be any according to requirements.

Moreover, all the details may be substituted by other, technically equivalent elements.

The disclosures in Italian Patent Application No. VR2012A000026 from which this application claims priority are incorporated herein by reference.

Where technical features mentioned in any claim are followed by reference signs, those reference signs have been included for the sole purpose of increasing the intelligibility of the claims and accordingly, such reference signs do not have any limiting effect on the interpretation of each element identified by way of example by such reference signs.

1-12. (canceled)

13. A potable water dispenser comprising a supporting structure for means of producing carbonated water, wherein said means for producing carbonated water comprise at least one dispensing assembly, which is connected or can be connected hermetically to the mouth of a container, said dispensing assembly having a water dispensing port, which is controlled by a first valve and is adapted to pour into said container a measured quantity of water, and a port for injecting pressurized gas into said container, which can be activated to carbonate the water poured into said container from said dispensing port, a venting port being provided in said dispensing assembly and being controlled by a second valve so as to allow the outflow of air from said container during the pouring of said measured quantity of water into said container by said dispensing port.

14. The dispenser according to claim 13, comprising control means which are adapted to actuate, upon the opening of said first valve, the opening of said second valve as well.

15. The dispenser according to claim 13, wherein said dispensing port is connected by way of said first valve to a potable water source.

16. The dispenser according to claim 13, wherein said injection port is connected, by means of a drawing valve, to a bottle for dispensing said pressurized gas.

17. The dispenser according to claim 13, comprising means for cooling the water that arrives from said potable water source.

18. The dispenser according to claim 13, wherein said potable water source is constituted by the water mains and/or by a tank which is installed on said supporting structure.

19. The dispenser according to claim 13, comprising, on said supporting structure, at least one spout for dispensing still water.

20. The dispenser according to claim 19, wherein said still water dispensing spout is constituted by said dispensing port.

21. The dispenser according to claim 13, wherein said dispensing assembly is connected to a mouth of said container removably, in order to allow the user to remove said container from said supporting structure.

22. The dispenser according to claim 13, comprising a venting valve, for an outflow from said container of the excess gas injected by said injection port.

23. The dispenser according to claim 13, comprising means for drawing carbonated water produced inside said container.

24. The dispenser according to claim 22, wherein said dispensing assembly comprises a base block, which supports said dispensing port, said injection port, said venting port and said venting valve.
